(19) United States
(12) Patent Application Publication
(10) Pub. No.: US 2026/0296053 A1
(43) Pub. Date: Oct. 1, 2026

(54) THERMAL PRINTHEAD AND THERMAL PRINTER

(71) Applicant: ROHM CO., LTD., Kyoto (JP)

(72) Inventors: Toshihiro KIMURA, Kyoto (JP); Yasuhiro YOSHIKAWA, Kyoto (JP)

(21) Appl. No.: 19/574,970

(22) Filed: Mar. 23, 2026

(30) Foreign Application Priority Data
Mar. 28, 2025 (JP) 2025-055078

(51) Int. Cl. B41J 2/365; B41J 2/325; B41J 2/335; B41J 11/04

(52) U.S. Cl. CPC B41J 2/365; B41J 2/325; B41J 2/33515; B41J 2/3358; B41J 11/04

(57) ABSTRACT

A thermal printhead includes: a substrate having a main surface and protrusions protruding from the main surface and extending in a main scanning direction; a resistor layer including heat generation portions arranged on the protrusions in the main scanning direction and configured to generate heat when supplied with an electric current; and a driver circuit configured to apply the electric current to the heat generation portions. Each protrusion includes a flat portion, a first inclined portion, a second inclined portion for connecting the first inclined portion to the main surface at a larger angle than the first inclined portion, a third inclined portion inclined to face the first inclined portion, and a fourth inclined portion for connecting the third inclined portion to the main surface at a larger angle than the third inclined portion. The heat generation portions are provided from the first inclined portion to the flat portion.

### CROSS-REFERENCE TO RELATED APPLICATION

This application is based upon and claims the benefit of priority from Japanese Patent Application No. 2025-055078, filed on March 28, 2025, the entire contents of which are incorporated herein by reference.

### TECHNICAL FIELD

The present disclosure relates to a thermal printhead and a thermal printer including the thermal printhead.

### BACKGROUND

In the related art, there is known a thermal printhead capable of performing printing on a print medium by generating heat through the application of an electric current to a plurality of heat generation portions.

### BRIEF DESCRIPTION OF DRAWINGS

The accompanying drawings, which are incorporated in and constitute a part of the specification, illustrate embodiments of the present disclosure.

FIG. 1 is a schematic diagram showing a configuration of a thermal printer according to a first embodiment.

FIG. 2 is a plan view showing a thermal printhead according to the first embodiment.

FIG. 3 is a plan view showing main parts of the thermal printhead according to the first embodiment.

FIG. 4 is an enlarged plan view of some of the main parts of the thermal printhead according to the first embodiment.

FIGS. 5A and 5B are schematic cross-sectional views of a thermal printhead of a comparative example and the thermal printhead according to the first embodiment.

FIG. 6 is a diagram showing printing using the thermal printer according to the first embodiment.

FIGS. 7A and 7B are diagrams for explaining states of substrate end portions of the thermal printhead of the comparative example and the thermal printhead according to the first embodiment.

FIGS. 8A and 8B are diagrams for explaining a relationship between flat portions of the thermal printhead according to the comparative example and the thermal printhead according to the first embodiment, and a medium.

FIG. 9 is a diagram for explaining a relationship between a lead-in angle and a required flat portion length with respect to a thickness of a paper.

FIGS. 10A and 10B are diagrams for explaining a current application signal sent by a control device to a driver circuit.

FIGS. 11A to 11C are diagrams for explaining changes in printing state due to differences in printing conditions.

FIG. 12 is a flowchart showing a control content of the control device according to the first embodiment.

FIG. 13 is a schematic diagram showing a configuration of a thermal printer according to a second embodiment.

FIGS. 14A to 14E are diagrams for explaining a mounting position of a resistor part according to the second embodiment.

FIG. 15 is a flowchart showing a control content of a control device according to the second embodiment.

FIG. 16 is a flowchart showing a control content of a control device according to a modification.

### DETAILED DESCRIPTION

Details of the embodiments of the present disclosure will be described with reference to the accompanying drawings. Note that identical or corresponding parts in the following drawings will be designated by same reference numerals, and the descriptions thereof will not be repeated. At least some of the configurations of the embodiments described below may be combined in any manner.

### First Embodiment

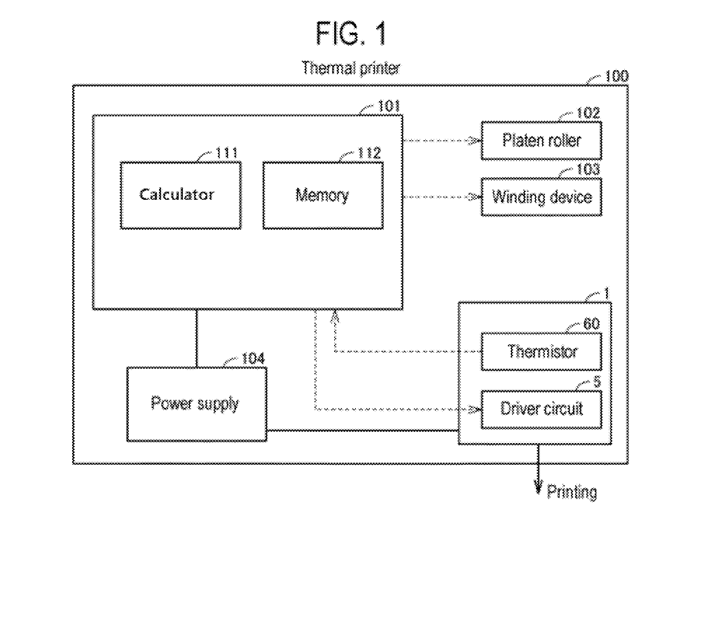

FIG. 1 is a schematic diagram showing a configuration of a thermal printer 100 according to a first embodiment. The thermal printer 100 includes a thermal printhead 1, a control device 101, a platen roller 102, a winding device 103, and a power supply 104.

The thermal printhead 1 includes a driver circuit 5 and a thermistor 60. The thermal printhead 1 performs printing on a print medium (also referred to as a medium) by generating heat. The driver circuit 5 applies an electric current to a plurality of heat generation portions (described below) based on signals from the control device 101 provided outside the thermal printhead 1. The thermistor 60 functions as a temperature sensor that measures a temperature around a driver IC 50.

The platen roller 102 is arranged to face the thermal printhead 1. The print medium is sandwiched between the platen roller 102 and the thermal printhead 1, and is transported with an operation of the platen roller 102. The print medium includes an ink ribbon and a paper. The ink on the ink ribbon is melted by thermal energy generated by the thermal printhead 1 and is transferred to the paper. The winding device 103 is a device for winding up the ink ribbon after transfer. The print medium may also be a thermal paper coated with a chemical that detects heat and undergoes a chemical reaction to change color.

The power supply 104 supplies an electric current to the thermal printhead 1 and the control device 101. The control device 101 includes a calculator 111 and a memory 112. The calculator 111 is a calculation body (computer) that executes predetermined processing. The calculator 111 is constituted with a processor such as an MCU (Micro Controller Unit), a CPU (Central Processing Unit), an MPU (Micro Processing Unit), a TPU (Tensor Processing Unit), or a GPU (Graphics Processing Unit).

The memory 112 is implemented with a storage device such as a random access memory (RAM), a read only memory (ROM), a nonvolatile memory such as a flash memory, or a magnetic disk. The memory 112 stores programs executed by the calculator 111, data used by the calculator 111, and the like. The memory 112 may also be interpreted as a processing circuit having a function of holding data or signals. For example, the memory 112 stores information about the printing, temperature information from the thermistor 60, and the like. The printing information includes information about a printing speed.

The calculator 111 calculates a current application signal to be sent to the driver circuit 5 based on the information stored in the memory 112. The current application signal is a command signal for controlling the application of current to a plurality of heat generation portions, which will be described later. The current application signal includes information such as the number of signal divisions and a current application time for the plurality of heat generation portions, which are determined based on whether the printing is low-speed printing, normal printing, or high-speed printing. In the thermal printhead 1, current application control is performed based on the current application signal sent from the control device 101 to the driver circuit 5.

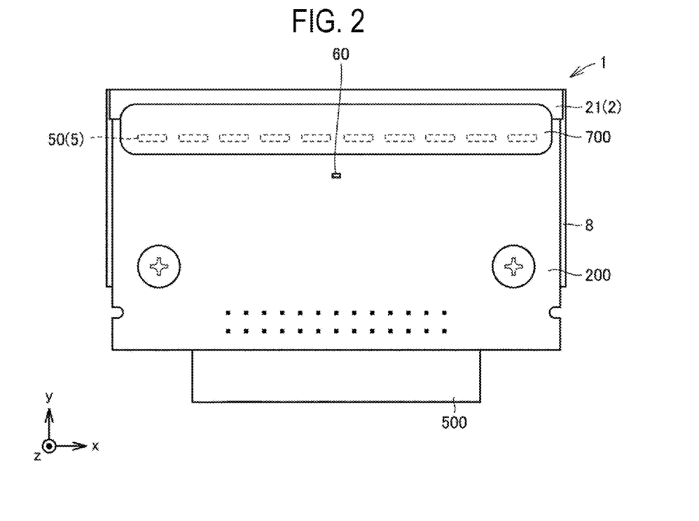

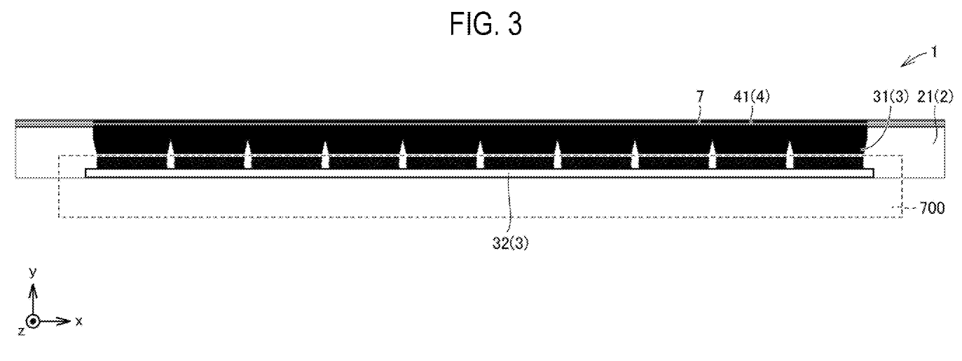

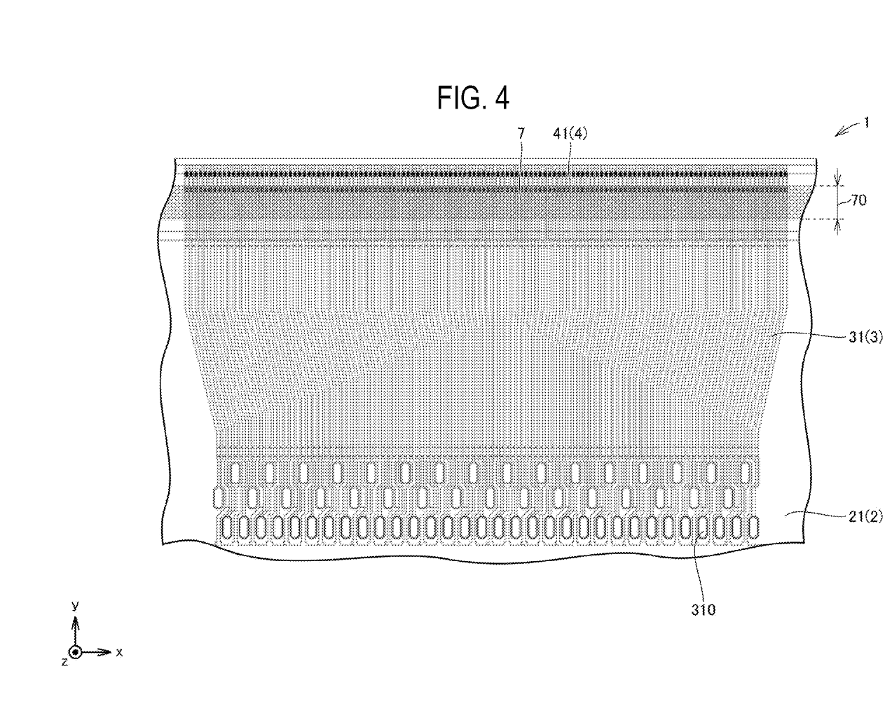

FIG. 2 is a plan view showing a thermal printhead according to the first embodiment. FIG. 3 is a plan view showing main parts of the thermal printhead according to the first embodiment. FIG. 4 is an enlarged plan view of some of the main parts of the thermal printhead according to the first embodiment. The thermal printhead 1 has a flat rectangular plate shape in a plan view. A longitudinal direction of the thermal printhead 1 shown in FIGS. 2 to 4 is defined as an x-direction (also referred to as a main scanning direction x), a lateral direction of the thermal printhead 1 is defined as a y-direction (also referred to as a sub-scanning direction y), and a thickness direction of the thermal printhead 1 is defined as a z-direction. The sub-scanning direction is a direction in which the print medium is transported, and the main scanning direction is a direction perpendicular to the sub-scanning direction.

The thermal printhead 1 includes a substrate 2, an electrode layer 3, a resistor layer 4, a driver circuit 5, a heat dissipation member 8, a thermistor 60, a connection board 200, and a protective resin 700. The substrate 2 is a plate-like member extending long in the main scanning direction x. The electrode layer 3 and the resistor layer 4 are provided on the substrate 2. A front surface of the substrate 2 is covered with a protective layer (not shown). The protective layer protects the electrode layer 3, the resistor layer 4, and the like. The substrate 2 has a main surface 21 on the positive side of the z direction and a back surface on the negative side of the z direction. The substrate 2 has protrusions 7 protruding from the main surface 21 and extending in the main scanning direction. The substrate 2 is a monocrystalline semiconductor made of, for example, Si.

The electrode layer 3 constitutes a conductive path for supplying an electric current to the resistor layer 4. The electrode layer 3 is made of a conductive material. The electrode layer 3 is made of a metallic material with a lower resistance than the resistor layer 4. The electrode layer 3 includes a Cu-made layer and a Ti-made layer interposed between the Cu-made layer and the resistor layer 4. The electrode layer 3 is formed on the substrate 2 and includes a common electrode 32 and a plurality of individual electrodes 31. A shape, arrangement, and material of each portion of the electrode layer 3 may be selected variously. The electrode layer 3 may be made of only Cu, or may be made of a metal containing Al.

The resistor layer 4 includes a plurality of heat generation portions 41. The plurality of heat generation portions 41 are portions of the resistor layer 4 that are exposed from the electrode layer between the plurality of individual electrodes 31 and the common electrode 32. The resistor layer 4 is made of, for example, TaN. A thickness of the resistor layer 4 is not particularly limited. The plurality of heat generation portions 41 are formed in the protrusions 7 of the substrate 2 so as to be spaced apart from each other along the main scanning direction x. The plurality of heat generation portions 41 are configured so as to generate heat when the electric current is applied thereto. Specifically, the plurality of heat generation portions 41 locally heat the print medium by being selectively applied with an electric current. A shape of the plurality of heat generation portions 41 is not particularly limited.

The connection board 200 is arranged on a negative side of the substrate 2 in the sub-scanning direction y. The connection board 200 is, for example, a printed circuit board or a flexible printed wiring board, and has a wiring pattern (not shown) formed thereon. A plurality of driver circuits 5 and a connector 500 are mounted on the connection board 200. A shape of the connection board 200 is not particularly limited. In this embodiment, the shape of the connection board 200 is rectangular with its longitudinal direction aligned with the main scanning direction x. A structure in which a plurality of connection boards 200 are connected to each other may also be used.

The driver circuit 5 includes a plurality of driver ICs 50. The plurality of driver ICs 50 applies an electric current to the plurality of heat generation portions 41, respectively. The plurality of driver ICs 50 is connected to the plurality of individual electrodes 31, respectively. The plurality of driver ICs 50 are covered with the protective resin 700. The protective resin 700 is formed so as to straddle the substrate 2 and the connection board 200. The protective resin 700 is made of, for example, an insulating resin.

The heat dissipation member 8 supports the substrate 2 and the connection board 200. The heat dissipation member 8 is provided to partially dissipate heat generated by the plurality of heat generation portions 41 to the outside via the substrate 2. The heat dissipation member 8 is a block-shaped member made of a metal such as Al.

As shown in FIG. 2, the thermistor 60 is arranged, for example, at the center in the main scanning direction x and on the negative side of the protective resin 700 in the sub-scanning direction y. In this way, the thermistor 60 may measure a temperature around the driver IC 50. However, the thermistor 60 does not measure the temperature directly but indirectly measures the temperature around the thermistor 60. An installation position of the thermistor 60 is not particularly limited. Two or more thermistors 60 may be arranged to detect temperatures at multiple positions.

As shown in FIG. 4, each of the plurality of individual electrodes 31 has a strip shape extending approximately in the sub-scanning direction y. The plurality of individual electrodes 31 have respective individual pads 310. The individual pads 310 are portions to which wires (not shown) for electrical connection with the driver ICs 50 are connected. The protective resin 700 covers the plurality of driver ICs 50, the individual pads 310, and the wires. In FIG. 4, the protrusion 7 has a flat portion 70 formed along the main scanning direction x so as to be substantially parallel to the main surface 21. A length of the flat portion 70 in the sub-scanning direction y is longer than that of the plurality of heat generation portions 41 in the sub-scanning direction y. However, the present disclosure is not limited thereto.

The common electrode 32 includes a connection portion extending in the x-direction and a plurality of strip-shaped portions extending from the connection portion in the sub-scanning direction y. The plurality of strip-shaped portions of the common electrode 32 are sandwiched between two individual electrodes 31 and connected to two adjacent heat generation portions 41. One of the two heat generation portions 41 is connected to one of the two individual electrodes 31 via a wiring on the corresponding end side of the substrate 2, and the other of the two heat generation portions 41 is connected to the other of the two individual electrodes 31 via a wiring on the corresponding end side of the substrate 2. With this configuration, when one individual electrode 31 is applied with the electric current, the two adjacent heat generation portions 41 simultaneously generate heat. The arrangement and shape of the electrode layer 3 are not particularly limited and may be any arrangement and shape.

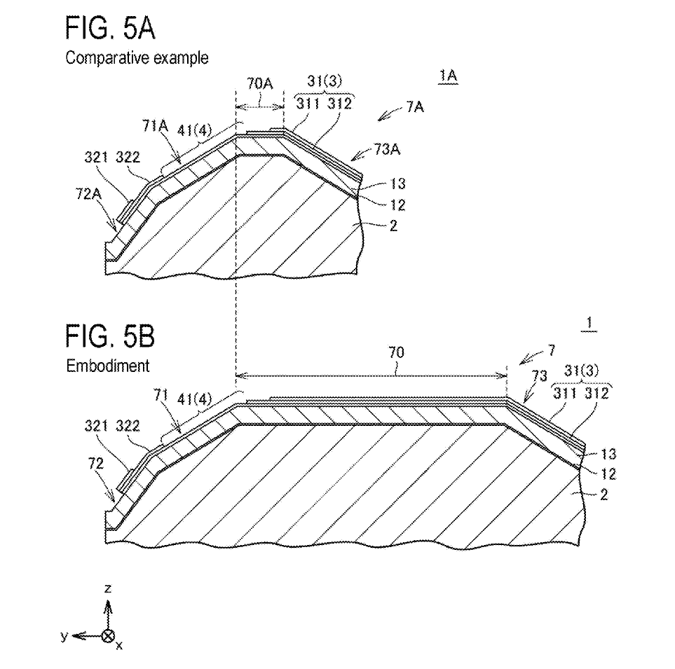

FIGS. 5A and 5B are schematic cross-sectional views of a thermal printhead 1A according to a comparative example and the thermal printhead 1 according to the first embodiment. FIG. 5A is a schematic cross-sectional view of the thermal printhead 1A according to the comparative example. FIG. 5B is a schematic cross-sectional view of the thermal printhead 1 according to the first embodiment. The thermal printhead 1A according to the comparative example and the thermal printhead 1 according to the first embodiment are made of the same material but differ in some dimensions. In FIGS. 5A and 5B, the protective layer covering the electrode layer 3 and the resistor layer 4 is omitted.

The thermal printhead 1 of FIG. 5B will now be described in detail. In the thermal printhead 1, the protrusions 7 are formed on the substrate 2 made of Si, and a plurality of layers are stacked on the substrate 2 in the z direction. The front surface (the main surface 21) of the substrate 2 including the protrusions 7 is covered with an insulating layer 13. The insulating layer 13 is made of TEOS (tetraethyl orthosilicate), which is an insulating material, and functions as a heat storage layer. The insulating layer 13 may be made of, for example, SiO₂ or SiN. A thickness of the insulating layer 13 is not particularly limited.

A thermal oxide film 12 is formed on the protrusions 7 so as to cover the protrusions 7, and the insulating layer 13 is stacked on an upper surface of the thermal oxide film 12. The thermal oxide film 12 has a function of stabilizing an interface between the substrate 2 and the insulating layer 13 and preventing the insulating layer 13 from peeling off from the substrate 2. A reflective layer may also be provided on the thermal oxide film 12 to reflect the heat from the heat generation portion and improve energy efficiency.

The resistor layer 4 is a layer made of TaN and supported by the substrate 2 via the insulating layer 13. The electrode layer 3 is arranged on the surface of the resistor layer 4. The electrode layer 3 includes wirings provided at positions closer to an end portion of the substrate 2 than the plurality of heat generation portions 41 (in the positive direction of the sub-scanning direction y), and a plurality of individual electrodes 31 provided at positions farther from the end portion of the substrate 2 than the plurality of heat generation portions 41 (in the positive direction of the sub-scanning direction y). The wiring material includes a first layer 321 made of Cu and a second layer 322 made of Ti. Each of the plurality of individual electrodes 31 includes a third layer 311 made of Cu and a fourth layer 312 made of Ti.

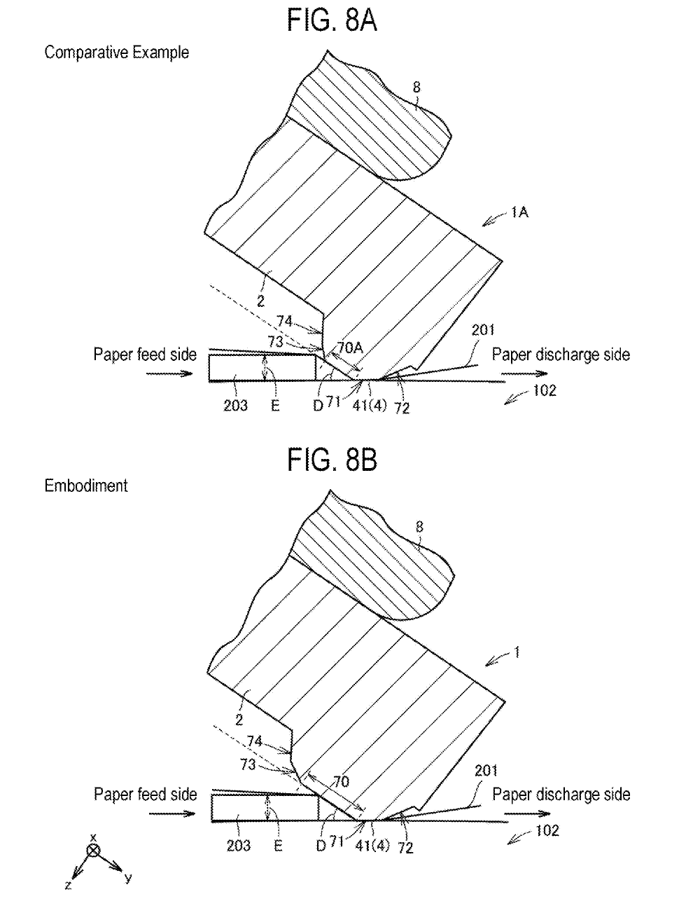

As shown in FIG. 5B , the protrusion 7 of the thermal printhead 1 according to the first embodiment includes a flat portion 70 that is substantially parallel to the main surface 21, a first inclined portion 71 that is connected to one end of the flat portion 70 and inclined toward the end portion of the substrate 2 in the sub-scanning direction y, and a second inclined portion 72 that connects the first inclined portion 71 to the main surface 21 at a larger angle than the first inclined portion 71. The protrusion 7 further includes a third inclined portion 73 that is connected to the other end of the flat portion 70 in the sub-scanning direction y and inclined opposite the first inclined portion 71, and a fourth inclined portion 74 that connects the third inclined portion 73 to the main surface 21 at a larger angle than the third inclined portion 73, which will be described with reference to FIG. 8B. The first inclined portion 71 and the third inclined portion 73 are arranged to face each other and have substantially the same angle with respect to the main surface 21. The second inclined portion 72 and the fourth inclined portion 74 are arranged to face each other and have substantially the same angle with respect to the main surface 21. The protrusion 7 is formed in a mountain shape with two stages of inclination by the plurality of inclined portions. The heat generation portions 41 are formed over a range from the first inclined portion 71 to the flat portion 70. A dimension of the flat portion 70 in the sub-scanning direction y is 100 μm to 500 μm.

Meanwhile, as shown in FIG. 5A , a protrusion 7A of the thermal printhead 1A according to the comparative example includes a flat portion 70A that is substantially parallel to the main surface 21, a first inclined portion 71A that is connected to one end of the flat portion 70A in the sub-scanning direction y and inclined toward the end portion of the substrate 2, and a second inclined portion 72A that connects the first inclined portion 71A to the main surface 21 at a larger angle than the first inclined portion 71A. The protrusion 7A further includes a third inclined portion 73A that is connected to the other end of the flat portion 70A in the sub-scanning direction y and inclined to face the first inclined portion 71A, and a fourth inclined portion (not shown) that connects the third inclined portion 73A to the main surface 21 at a larger angle than the third inclined portion 73A. The first inclined portion 71A and the third inclined portion 73A are arranged to face each other and have substantially the same angle with respect to the main surface 21. The second inclined portion 72A and the fourth inclined portion 74 are arranged to face each other and have approximately the same angle with respect to the main surface 21. The protrusion 7A is formed in a mountain shape with two stages of inclination by the plurality of inclined portions. The plurality of heat generation portions 41 are formed over a range from the first inclined portion 71A to the flat portion 70A. A dimension of the flat portion 70A in the sub-scanning direction y is shorter than 100 μm.

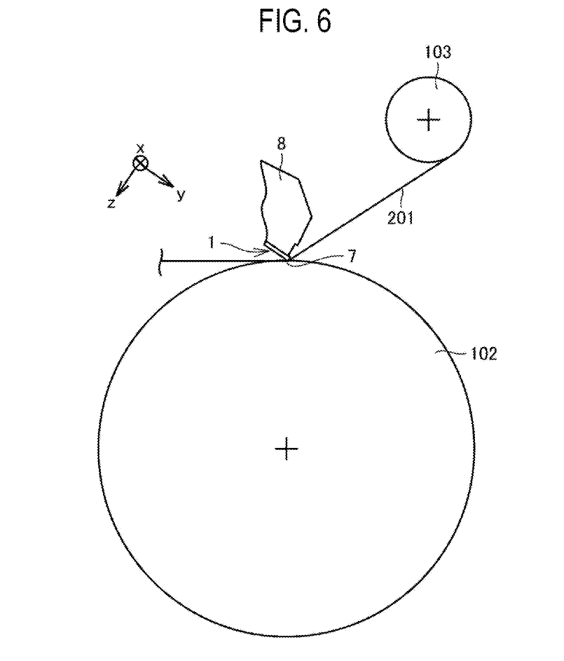

FIG. 6 is a diagram showing the printing using the thermal printer 100 according to the first embodiment. In the thermal printer 100, the print medium is arranged between the protrusions 7 of the thermal printhead 1 and the platen roller 102. The print medium is composed of an ink ribbon 201 and a paper (not shown), and is transported from a paper feed side to a paper discharge side with the rotation of the platen roller 102. The ink ribbon 201 is wound up with the rotation of the winding device 103. The heat dissipation member 8 is arranged on a back surface (the negative direction of the z-direction) of the thermal printhead 1. The heat dissipation member 8 partially dissipates the heat generated by the plurality of heat generation portions 41 to the outside. The heat dissipation member 8 is made of a metal such as aluminum.

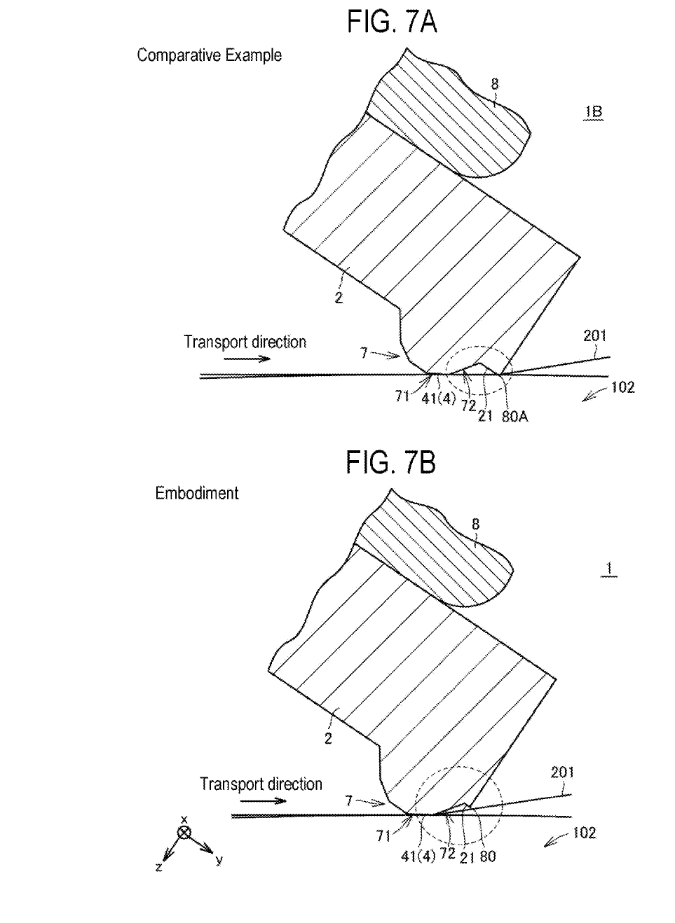

FIGS. 7A and 7B are diagrams for explaining states of the end portion of the substrate of the thermal printhead 1B according to the comparative example and the thermal printhead 1 according to the first embodiment. FIG. 7A is a schematic cross-sectional view of the end portion of the substrate of the thermal printhead 1B according to the comparative example. FIG. 7B is a schematic cross-sectional view of the end portion of the substrate of the thermal printhead 1 according to the first embodiment. The thermal printhead 1B according to the comparative example and the thermal printhead 1 according to the first embodiment are made of the same material but have some different dimensions.

As shown in FIG. 7A, the thermal printhead 1B according to the comparative example has the shortest distance of longer than 10 μm in the sub-scanning direction y from a boundary between the second inclined portion 72 and the main surface 21 to an end portion 80A of the substrate 2. Due to this structure, in the thermal printhead 1B according to the comparative example, when the ink ribbon 201 is wound up, the ink ribbon remains in contact with the paper while being transported, preventing the ink ribbon from peeling off. As a result, the thermal printhead 1B according to the comparative example may not reliably peel off the ink ribbon 201. In particular, during the low-speed printing in which the printing speed is slow, the winding speed of the ink ribbon 201 is slowed down, causing the ink ribbon to cool while being transported in contact with the paper, and then peel off. This results in a significant reduction in print quality.

In contrast, in the thermal printhead 1 according to the first embodiment, as shown in FIG. 7B, the shortest distance in the sub-scanning direction y from the boundary between the second inclined portion 72 and the main surface 21 to the end portion 80 of the substrate 2 is 0 to 10 μm. Due to this structure, in the thermal printhead 1 of the first embodiment, the contact distance between the ink ribbon 201 and the print medium is shortened when the ink ribbon 201 is wound up, and peeling occurs. As a result, the thermal printhead 1 according to the first embodiment improves the ease of peeling of the ink ribbon 201 compared to the thermal printhead 1B according to the comparative example, so that clear printing becomes possible.

FIGS. 8A and 8B are diagrams for explaining a relationship between the flat portions of the thermal printhead 1A according to the comparative example and the thermal printhead 1 according to the first embodiment, and the medium. FIG. 8A is a diagram for explaining a relationship between the flat portion 70A of the thermal printhead 1A according to the comparative example and the medium. FIG. 8B is a diagram for explaining a relationship between the flat portion 70A of the thermal printhead 1 according to the first embodiment and the medium.

In FIGS. 8A and 8B, a thickness of a paper 203 is assumed to be E, and an angle between the platen roller 102 and the flat portion 70 (70A) when the plurality of heat generation portions 41 are pressed against the platen roller 102 is assumed to be D. The angle D is also called a lead-in angle. A fourth inclined portion 74 is formed on the paper feed side of the flat portion 70 (70A) to connect the third inclined portion 73 and the main surface 21 at a larger angle than the third inclined portion 73 with respect to the main surface 21. The first inclined portion 71 and the third inclined portion 73 are arranged to face each other, and have substantially the same angle with respect to the main surface 21. In addition, the second inclined portion 72 and the fourth inclined portion 74 are arranged to face each other, and have substantially the same angle with respect to the main surface 21.

The thermal printhead 1A according to the comparative example has a shorter flat portion 70A than that according to the first embodiment. Therefore, as shown in FIG. 8A, when the paper 203 is thicker than normal, the end portion of the paper 203 may come into contact with the third inclined portion 73. Accordingly, the paper 203 undergoes two-stage contact in which the paper 203 comes into contact with the third inclined portion 73 at an angle steeper than the angle D and then comes into contact with the flat portion 70A. Therefore, the print medium may vibrate, the thermal head may bounce, and the paper 203 may become jammed due to an inability to climb over a stepped portion on the print medium.

In contrast, the thermal printhead 1 according to the first embodiment has a longer flat portion 70 than that according to the comparative example. Therefore, as shown in FIG. 8B, even if the paper 203 is thicker than normal, the end portion of the paper 203 comes into contact with the flat portion 70 only once at the angle D. In this way, when the length of the flat portion 70 is a certain length, such as 100 μm to 500 μm, it is possible to prevent vibration of the print medium. In addition, it is possible to smoothly climb over the stepped portion on the print medium. This enables stable transport.

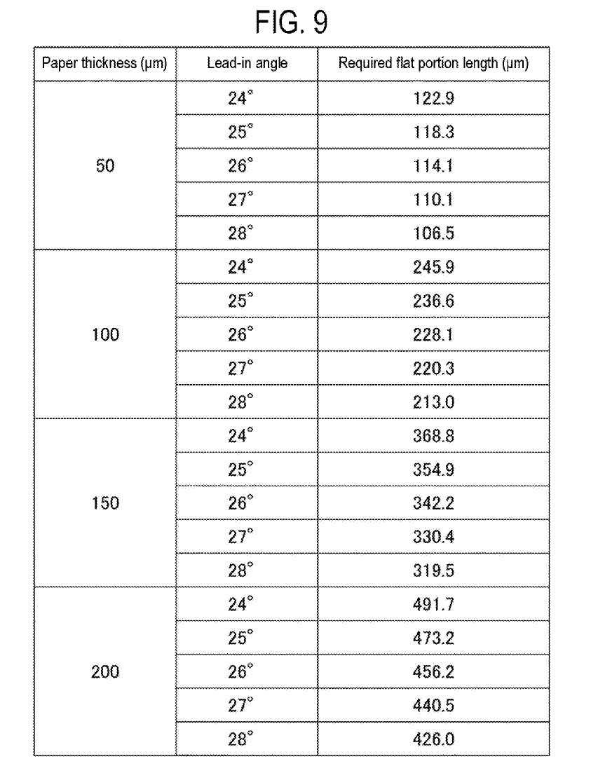

FIG. 9 is a diagram for explaining a relationship between the lead-in angle and a required flat portion length with respect to the thickness of the paper 203. The required flat portion length is a length of the flat portion 70 at which the print medium does not vibrate and the thermal print head does not bounce. In order to verify this condition, FIG. 9 shows results of verifying a range of lengths of the flat portion 70 by variously changing the paper thickness and the lead-in angle in conceivable usage situations.

As shown in FIG. 9, when the paper thickness is 50 μm, the required flat portion length is in a range of 122.9 μm to 106.5 μm for the lead-in angle in a range of 24° to 28°. When the paper thickness is 100 μm, the required flat portion length is in a range of 245.9 μm to 213.0 μm for the lead-in angle in the range of 24° to 28°. When the paper thickness is 150 μm, the required flat portion length is in a range of 368.8 μm to 319.5 μm for the lead-in angle in the range of 24° to 28°. When the paper thickness is 200 μm, the required flat portion length is in a range of 491.7 μm to 426.0 μm for the lead-in angle in the range of 24° to 28°.

The lead-in angle may preferably be approximately 26°. Considering the thickness of the paper 203 and the angles around the preferable lead-in angle, it was determined that the length of the flat portion 70 should be 100 μm to 500 μm. Taking these circumstances into consideration, the thermal printhead 1 according to the first embodiment sets the length of the flat portion 70 to 100 μm to 500 μm, thereby suppressing the vibration of the print medium and the bouncing of the thermal head to stabilize the transport. This makes it possible for the thermal printhead 1 to stably perform the printing and reduce the occurrence of uneven printing. In particular, the thermal printhead 1 according to the first embodiment may perform stable printing without generating vibrations during the low-speed or high-speed printing. Formation of a flat portion 70 that exceeds 500 μm is undesirable because it increases the size of the substrate 2 and increases costs.

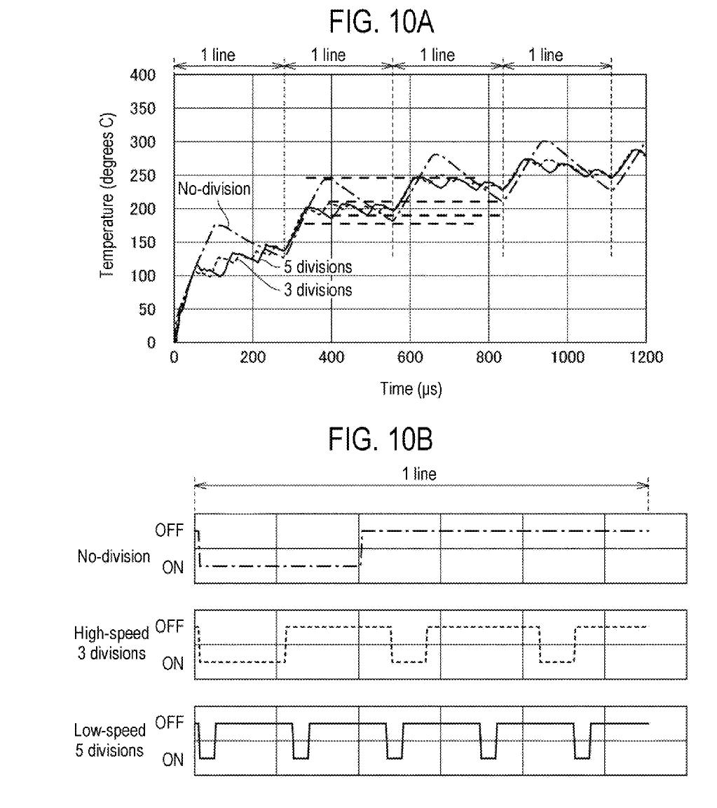

FIGS. 10A and 10B are diagrams for explaining current application signals sent by the control device 101 to the driver circuit 5. FIG. 10A is a diagram showing an example of a relationship between a time and a temperature for each current application signal. FIG. 10B is a diagram showing an example of a number of divisions for each current application signal. The current application signal includes the number of signal divisions and the current application time for the plurality of heat generation portions 41. The number of signal divisions is the number of times that the corresponding heat generation portion among the plurality of heat generation portions 41 is supplied with an electric current per line, which is a printing unit. In FIG. 10B, ON indicates that an electric current is being applied, and OFF indicates that no electric current is being applied. FIGS. 10A and 10B show fluctuations in the temperatures of the plurality of heat generation portions 41 during a low-speed printing.

In FIG. 10A, the current application signal for non-division is indicated by a one-dot chain line, the current application signal for a division number of three is indicated by a dashed line, and the current application signal for a division number of five is indicated by a solid line. As shown in FIG. 10A, a width between a temperature rise peak and a temperature fall peak is greater for non-division than for division. Thus, the temperature fluctuation is greater for non-division than for division, resulting in a greater degree of cooling. As a result, a cooling time due to non-current application is longer for non-division than for division, and the ink on the ink ribbon 201 may not melt, undesirably resulting in uneven printing. Further, the temperature fluctuation is greater for non-division than for division, resulting in a higher peak temperature. However, a higher peak temperature could result in excessive temperature rise, potentially causing the ink to peel off or the ink ribbon 201 to tear.

On the other hand, in the case of division, the width between the temperature rise peak and the temperature fall peak is smaller than in the case of non-division. Thus, in the case of division, the temperature fluctuation is smaller than in the case of non-division, and therefore the cooling time due to non-current application is shorter than in the case of non-division. As a result, in the case of division, the temperature may be maintained above an ink melting temperature, thereby preventing situations where the ink does not melt or the ink ribbon 201 breaks. In this way, in the low-speed printing in which the printing speed is slow, in the case of division, the printing may be clearer than in the case of non-division. This makes it possible to stably perform the printing.

FIG. 10B shows an example of the number of divisions for each current application signal. In the case of non-division, the corresponding heat generation portion among the plurality of heat generation portions 41 is applied with an electric current once per line, which is the printing unit. In other words, in the case of non-division, the current application signal has a waveform in which, when printing one line, the current application is executed once and then non-current application is restored. In contrast, in the case of division, the number of divisions, which is the number of times current application occurs per line, is set to 3 or 5. The number of divisions may be set to 2 or more to reduce the temperature fluctuations.

As shown in FIG. 10B, the number of divisions is set to be greater for the low-speed printing (5 divisions) than for the high-speed printing (3 divisions). This is because, in the low-speed printing, the platen roller 102 transports the print medium and the winding device 103 winds up the ink ribbon 201 more slowly than in the high-speed printing, resulting in a longer non-current application time, which makes it easier to cool the ink ribbon. Thus, when peeling occurs in this state, printability will be degraded. Therefore, in the low-speed printing, by increasing the number of divisions of the current application signal per line compared to the high-speed printing, peeling will occur while maintaining the reactivity of the ink ribbon. This makes it possible to stably perform the transfer.

As an example, when the printing speed is 30 mm/sec or less in the low-speed printing, it is preferable to set the number of divisions of the current application signal to 2 to 100. When the printing speed is 50 to 30 mm/sec, it is preferable to set the number of divisions of the current application signal to 2 to 10 from the viewpoint of stable printing. Even when the printing speed is 500 mm/sec or more in the high-speed printing, the number of divisions of the current application signal may be set to 2 to 10, just as when the printing speed is 50 to 30 mm/sec.

In the high-speed printing, when the heat generation portions 41 are not at the ink melting temperature when printing starts, the printing will proceed before the ink melts. For this reason, as shown in FIG. 10B, in the high-speed printing, the current application time of the first current application for a first line when printing starts is set to be longer than the current application times of subsequent current application signals, compared to the low-speed printing. This allows the ink to instantly reach its melting temperature when printing starts in the high-speed printing.

In the medium-speed printing in which the printing speed is between the low-speed printing and the high-speed printing, the number of divisions of the current application signal may be set to 3 as in the high-speed printing, and the current application time of the first current application signal for the first line when printing starts may be set to be the same as in the low-speed printing.

The setting to make the current application time of a first current application signal for the first line when printing starts to be longer than the current application time of subsequent current application signals may be the same regardless of the printing speed. The current application time of the first current application signal for the first line may be set to be relatively longer when printing starts in the order of the low-speed printing, the medium-speed printing, and the high-speed printing.

The number of divisions of the current application signal may be set to be the same regardless of the printing speed, as long as the number of divisions of the current application signal is at least two or more.

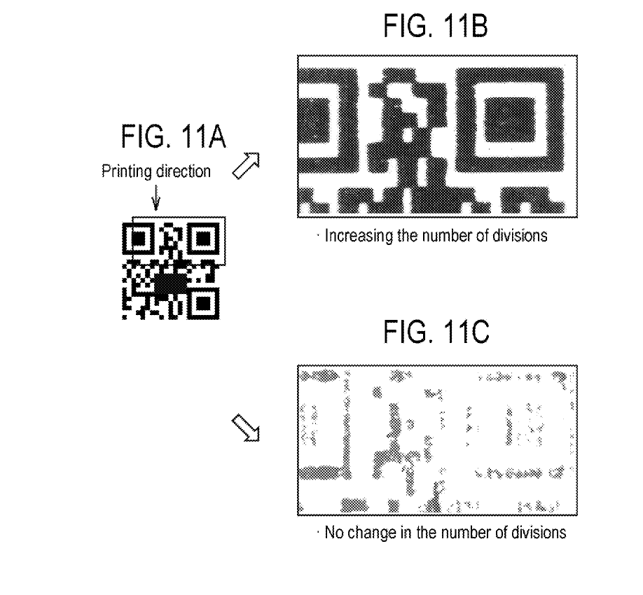

FIGS. 11A to 11C are diagrams for explaining changes in printing state due to differences in printing conditions. FIG. 11A shows printing of a two-dimensional code, which is an example of printing. The direction of the arrow in FIG. 11A indicates the printing direction. FIGS. 11B and 11C are enlarged views of a partial region when printing a printing pattern of FIG. 11A under different conditions during the low-speed printing. FIG. 11B shows a case where the number of divisions of the current application signal is increased compared to the normal setting during the low-speed printing, and FIG. 11C shows a case where the number of divisions of the current application signal is decreased compared to the normal setting during the low-speed printing.

As shown in FIG. 11B, when the number of divisions of the current application signal is increased from an initial setting during the low-speed printing, the temperature fluctuation of the plurality of heat generation portions 41 is small. Therefore, the temperature may be maintained at or above a melting point of the ink. Stable printing may also be performed because the ink ribbon 201 does not tear. Further, since the ink ribbon 201 is less likely to tear, a ribbon base material may be made thinner. Since the ink ribbon 201 may be wound longer with the same winding diameter, it is possible to be configured to continuously perform the operation for a long period of time.

Meanwhile, as shown in FIG. 11C, when the number of divisions of the current application signal is reduced to zero during the low-speed printing, the ink does not melt due to large temperature fluctuations in the plurality of heat generation portions 41, and the transfer of the ink is not performed sufficiently. This makes it difficult to stably perform the printing. In addition, when the number of divisions of the current application signal is reduced to zero, the peak temperature becomes too high, which may cause the ink to peel off or the ink ribbon 201 to tear. This makes it difficult to stably perform the printing.

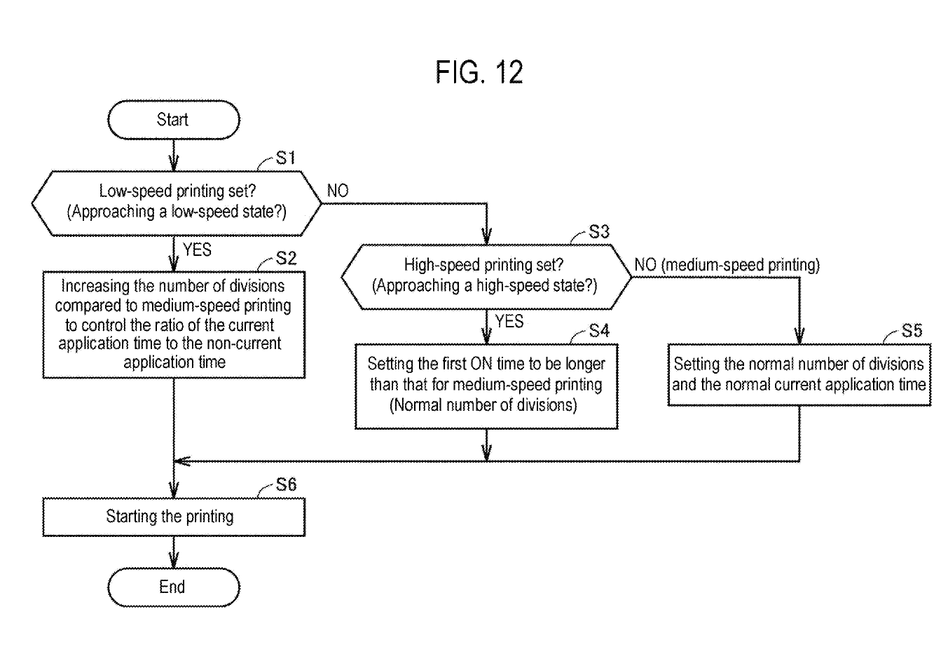

Next, a control executed by the control device 101 according to the first embodiment will be described with reference to FIG. 12. FIG. 12 is a flowchart illustrating the control executed by the control device 101 according to the first embodiment. Referring to FIG. 12, in Step (hereinafter simply referred to as "S") 1, the control device 101 determines whether or not the low-speed printing is set (or whether or not the printer is in a low-speed state). When the control device 101 determines that the low-speed printing is set (or the printer is in the low-speed state) (YES in S1), the control device 101 increases the number of divisions of the current application signal compared to the medium-speed printing (normal printing) to control a ratio of the current application time to the non-current application time (S2). Specifically, in S2, the control device 101 also controls the ratio of the current application time to the non-current application time among the divisions of the current application signal for the first line when printing starts, thereby achieving better temperature stabilization. Since the number of divisions of the current application signal may be the same for the medium-speed printing and the high-speed printing, S2 is the same as setting the number of divisions of the current application signal to be increased compared to the high-speed printing.

When it is determined in S1 that the setting is not for the low-speed printing (that is, the printer is not in the low-speed state) (NO in S1), the control device 101 determines whether or not the setting is for the high-speed printing (or whether the printer is in a high-speed state) (S3). When it is determined in S3 that the setting is for the high-speed printing (that is, the printer is in the high-speed state) (YES in S3), the control device 101 sets the current application time of the first current application signal for the first line to be longer than that for the medium-speed printing (S4). In S4, the control device 101 also executes control to set the number of divisions of the current application signal to be the same as the number of divisions for the normal printing.

When it is determined in S3 that the setting is not for the high-speed printing (that is, that the printer is not in the high-speed state) (NO in S3), the control device 101 determines that the setting is for the medium-speed printing and proceeds to the process of S5. In the process of S5, the control device 101 sets the number of divisions of the current application signal to the normal number of divisions and sets the current application time of the first current application signal for the first line to the normal current application time.

The control device 101 starts the printing (S6) based on the setting of the current application signal in S2, S4, and S5, and then ends the process. Specifically, in the process of S6, the control device 101 uses the printing information (for example, a print pattern) stored in the memory 112 to cause the calculator 111 to calculate print settings related to the number of divisions of the current application signal and the current application time. The control device 101 transmits the current application signal set by the calculation of the calculator 111 to the driver circuit 5. Thus, the thermal printer 100 and the thermal printhead 1 may execute the printing using the setting of the current application signal setting corresponding to the printing speed, thereby improving printing stability.

### Second Embodiment

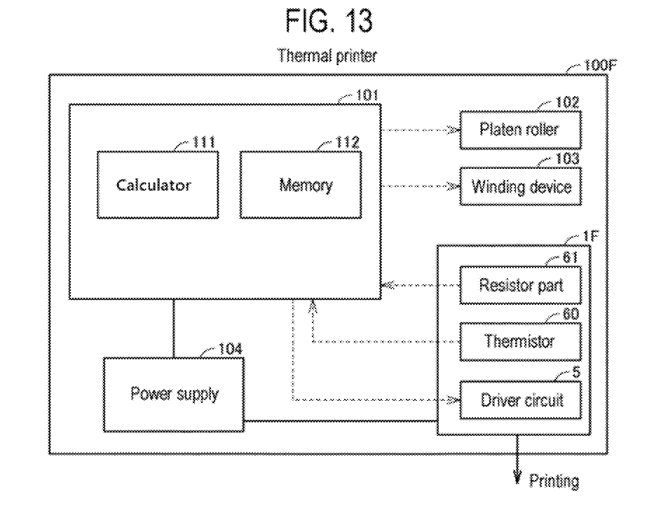

FIG. 13 is a schematic diagram showing a configuration of a thermal printer 100F of a second embodiment. Compared to the thermal printer 100 according to the first embodiment, the thermal printer 100F has the same configuration as that of the thermal printer 100 according to the first embodiment except that a resistor part 61 is arranged in the thermal printhead 1F. In FIG. 13, differences from the first embodiment will be mainly described, and redundant descriptions thereof will be omitted.

The resistor part 61 is a component that generates heat when supplied with an electric current. The control device 101 executes control to change the supply of the electric current to the resistor part 61 based on a detection value from the thermistor 60. A mounting position of the resistor part 61 will be specifically described.

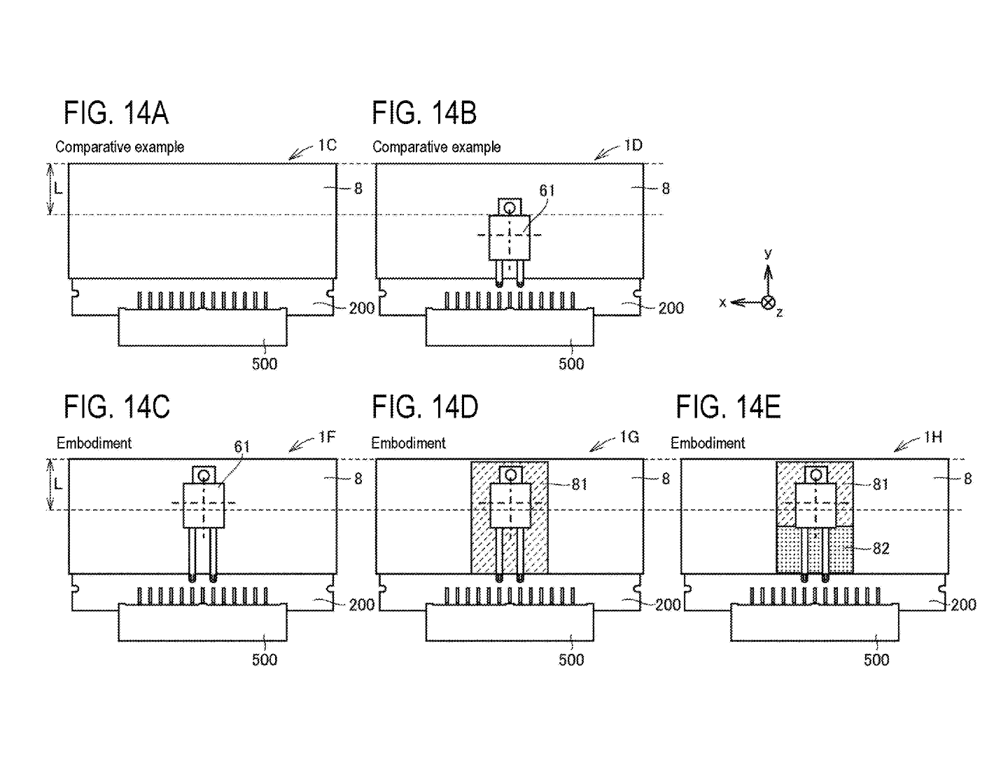

FIGS. 14A to 14E are diagrams for explaining the mounting position of the resistor part 61 according to the second embodiment. FIGS. 14A to 14E show the back surface of the thermal printhead. FIGS. 14A and 14B show thermal printheads 1C and 1D according to comparative examples, while FIGS. 14C to 14E show thermal printheads 1F to 1H according to the second embodiment. A surface shape of each thermal printhead is the same as the plan-view shape of the thermal printhead 1 shown in FIG. 2. A distance L in FIG. 14 is a range from a position closer to the plurality of heat generation portions 41 on the substrate 2 to the center of the heat dissipation member 8 in the sub-scanning direction y.

Compared to the thermal printhead 1D shown in FIG. 14B, as shown in FIGS. 14C to 14E, it is effective to install the center of the resistor part 61 on the back surface of the thermal printheads 1F, 1G, and 1H, particularly within a range (the distance L) from a position closer to the center of the heat dissipation member 8 to a position closer to the plurality of heat generation portions 41 on the substrate 2 in the sub-scanning direction y. Further, by locating the resistor part 61 near the center of the heat dissipation member 8 in the main scanning direction x, heat from the resistor part 61 is transferred via the heat dissipation member 8, thereby warming the entire thermal printhead. This increases the temperature of the plurality of heat generation portions 41. Two or more resistor parts 61 may be installed to heat the entire thermal printhead at multiple positions.

In addition, when the resistor part 61 is installed on the back surface of the heat dissipation member 8, a height of the resistor part 61 is increased in proportion thereto. Therefore, as shown in FIG. 14D, the heat dissipation member 8 may be cut out around the resistor part 61, and the resistor part 61 may be installed inside the cutout 81 formed in the heat dissipation member 8. In this case, heat from the resistor part 61 is more easily transferred to the front surface of the thermal printhead 1F, and the temperature around the heat generation portions 41 is increased.

In a case in which the resistor part 61 has leads, the resistor part 61 may be electrically connected to the connection board 200 via the leads. However, in order to use the resistor part 61 in this way, the leads need to be bent for such a connection. Since physical and electrical contact between the leads and the heat dissipation member 8 should be avoided, it is also effective to additionally cut out the heat dissipation member 8 in a step-like shape only at lead locations. For example, as shown in FIG. 14E, cutouts 82 that are deeper than the cutout 81 may be formed at the lead positions. The leads may also be bent at a right angle or obliquely for the connection to the connection board 200.

Here, when an ambient temperature is low (for example, below 5 degrees C) at the start of printing and the number of divisions is increased due to the low-speed printing, the heat generation portions 41 may not reach the desired temperature and may not be stable, especially when printing first few dots. The thermal printer 100F according to the second embodiment may increase the temperature of the thermal head, which includes the plurality of heat generation portions 41, at the start of printing, and therefore may execute stable printing even at the start of printing. The control device 101 may also perform preliminary application of an electric current (hereinafter referred to as "preliminary current application") so that the plurality of heat generation portions 41 generate heat before starting the printing.

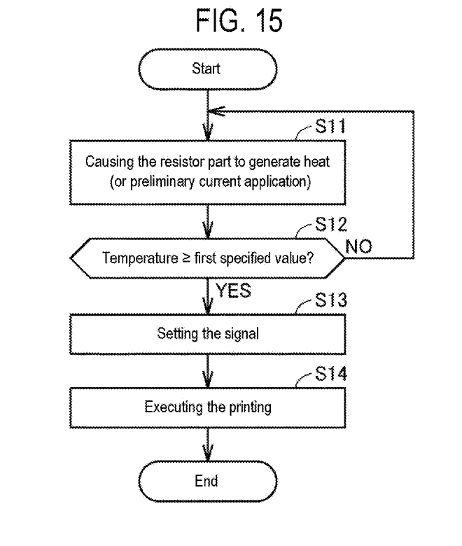

FIG. 15 is a flowchart showing a control content of the control device 101 according to the second embodiment. First, in S11, the control device 101 supplies the electric current to the resistor part 61 so that the resistor part 61 generates heat. In the process of S11, the control device 101 may perform the preliminary current application, in which the electric current is applied to the plurality of heat generation portions 41 in advance, instead of the heat generation of the resistor part 61. The control device 101 may perform the preliminary current application so that the plurality of heat generation portions 41 generate heat in addition to the heat generation of the resistor part 61.

Next, the control device 101 determines whether or not the temperature detected by the thermistor 60 is equal to or greater than a first specified value (a first temperature) (S12). When the control device 101 determines that the temperature detected by the thermistor 60 is less than the first specified value (the first temperature) (NO in S12), the control device 101 repeats the process of S11. When the control device 101 determines that the temperature detected by the thermistor 60 is equal to or greater than the first specified value (the first temperature) (YES in S12), the control device 101 sets a current application signal related to the electric current to be sent to the driver circuit 5 (S13).

The determination of YES in S12 indicates that an initial printing is stable. Next, the control device 101 executes the printing using the setting of the current application signal made in S13 (S14), and ends the process.

### Modification

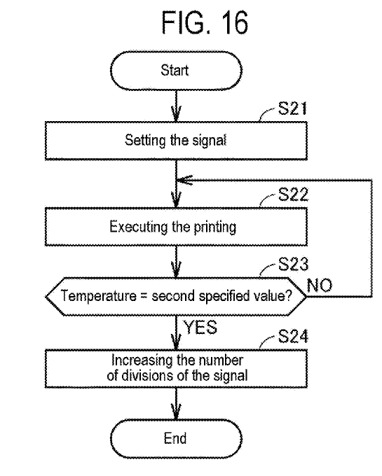

FIG. 16 is a flowchart showing a control content of the control device 101 according to a modification. First, in S21, the control device 101 sets the current application signal to be sent to the driver circuit 5. Next, the control device 101 executes the printing using the setting of the current application signal made in S21 (S22).

Next, the control device 101 determines whether or not the temperature detected by the thermistor 60 has reached a second specified value (a second temperature) (S23). When the control device 101 determines that the temperature detected by the thermistor 60 has not reached the second specified value (the second temperature) (NO in S23), the control device 101 repeats the process of S22. When the control device 101 determines that the temperature detected by the thermistor 60 has reached the second specified value (the second temperature) (YES in S23), the control device 101 increases the number of divisions of the current application signal (S24), executes the printing using the increased current application signal, and ends the process.

Here, the second specified value (the second temperature) is a temperature at which the ink melts. The control device 101 controls the current application signal so that the number of divisions of the current application signal after the temperature of the thermistor 60 reaches the second specified value (the second temperature) is greater than the number of divisions of the current application signal before the temperature reaches the second specified value (the second temperature). In this way, by increasing the number of divisions of the current application signal when the temperature reaches the temperature at which the ink melts, the control device 101 may suppress the temperature fluctuations more than before the number of divisions is increased. This makes it possible to stably perform the printing.

Various aspects of the present disclosure are summarized below as supplementary notes.

### Supplementary Note

(1) A thermal printhead 1 of the present disclosure includes: a substrate 2 having a main surface 21 and protrusions 7 protruding from the main surface 21 and extending in a main scanning direction x; a resistor layer 4 including a plurality of heat generation portions 41 arranged on the protrusions 7 of the substrate 2 in the main scanning direction x and configured to generate heat when supplied with an electric current; and a driver circuit 5 configured to apply the electric current to the plurality of heat generation portions 41 based on an external signal. Each of the protrusions 7 includes a flat portion 70 substantially parallel to the main surface 21, a first inclined portion 71 configured to be connected to one end of the flat portion 70 in a sub-scanning direction y and inclined toward an end portion of the substrate 2, a second inclined portion 72 configured to connect the first inclined portion 71 to the main surface 21 at a larger angle than the first inclined portion 71 with respect to the main surface 21, a third inclined portion 73 configured to be connected to a second end of the flat portion 70 in the sub-scanning direction y and inclined to face the first inclined portion 71, and a fourth inclined portion 74 configured to connect the third inclined portion 73 to the main surface 21 at a larger angle than the third inclined portion 73 with respect to the main surface 21. The plurality of heat generation portions 41 are provided over a range from the first inclined portion 71 to the flat portion 70. A dimension of the flat portion 70 in the sub-scanning direction y is 100 μm to 500 μm.

With this configuration, by setting the dimension of the flat portion 70 in the sub-scanning direction y to 100 μm to 500 μm, vibration of the print medium or bouncing due to jumping up of the head is not generated during low-speed or high-speed printing. Thus, the printing may be stably performed without clogging by climbing over a stepped portion on the printing paper.

(2) In the thermal printhead 1 of (1) above, a shortest distance in the sub-scanning direction y from a boundary between the second inclined portion 72 and the main surface 21 to the end portion 80 of the substrate 2 is 0 to 10 μm.

With this configuration, the ink ribbon 201 may be stably peeled off when the ink ribbon 201 is wound up.

(3) A thermal printer 100 of the present disclosure includes: the thermal printhead 1 of (1) or (2) above; and a control device 101 configured to transmit a signal to the driver circuit 5. The control device 101 transmits, to the driver circuit 5, the signal having a number of divisions of 2 or more, which is the number of times that the corresponding heat generation portion among the plurality of heat generation portions 41 is applied with the electric current per line which is a printing unit.

With this configuration, the temperature may be maintained above a melting point of the ink, and the ink ribbon 201 may be prevented from breaking, which makes it possible to stably perform the printing.

(4) In the thermal printer 100 of (3) above, the control device 101 controls the signal so that the number of divisions of the signal when a printing speed is a first speed (low printing speed) is greater than the number of divisions of the signal when the printing speed is a second speed (high printing speed) faster than the first speed.

With this configuration, it is possible to improve the ease of peeling of the ink ribbon 201 when the printing speed is the first speed.

(5) In the thermal printer 100 of (3) or (4) above, the control device 101 controls the signal so that a current application time of a first signal when printing starts is longer than a current application time of a subsequent signal.

With this configuration, the ink may be made to reach its melting point instantaneously at the start of the printing.

(6) In the thermal printer 100 of (3) or (4) above, the control device 101 controls the signal so that a current application time of a first signal at the start of printing when a printing speed is a second speed (high printing speed) is longer than a current application time of the first signal at the start of the printing when the printing speed is a first speed (low printing speed) slower than the second speed.

With this configuration, at the start of the printing when the printing speed is the second speed, the ink may be made to reach its melting point instantaneously.

(7) The thermal printer 100 (100F) of any one of (3) to (6) above further includes: a temperature sensor (the thermistor 60) configured to be capable of measuring a temperature around the driver IC 50. The control device 101 applies the electric current to the plurality of heat generation portions 41 in advance so that the temperature of the temperature sensor (the thermistor 60) is equal to or higher than a first temperature before printing starts.

With this configuration, the temperatures of the plurality of heat generation portions 41 may be increased at the start of the printing, making it possible to stably perform the printing.

(8) The thermal printer 100 (100F) of any one of (3) to (7) above further includes: a temperature sensor (the thermistor 60) configured to be capable of measuring a temperature around the driver IC 50; a heat dissipation member 8 configured to partially dissipate the heat generated by the plurality of heat generation portions 41 to the outside via the substrate 2; and a resistor part 61 whose center position is located in a range from a position closer to the plurality of heat generation portions 41 to the center of the heat dissipation member 8 in the sub-scanning direction y and located near the center of the heat dissipation member 8 in the main scanning direction x, wherein the resistor part 61 is installed on a back surface of the heat dissipation member 8 or at a location where a cutout is provided inside the heat dissipation member 8, and configured to generate heat when supplied with the electric current. The control device 101 applies the electric current to the resistor part 61 so that the temperature of the temperature sensor (the thermistor 60) is equal to or higher than a first temperature before printing starts.

With this configuration, the temperatures of the plurality of heat generation portions 41 may be increased at the start of the printing, making it possible to stably perform the printing.

(9) The thermal printer 100 (100F) of any one of (3) to (8) above further includes: a temperature sensor (the thermistor 60) configured to be capable of measuring a temperature around the driver IC 50. The control device 101 controls the signal so that the number of divisions of the signal after the temperature of the temperature sensor (the thermistor 60) reaches a second temperature is greater than the number of divisions of the signal before the temperature of the temperature sensor (the thermistor 60) reaches the second temperature.

With this configuration, temperature fluctuations may be suppressed more than before the number of divisions is increased, making it possible to stably perform the printing.

(10) The thermal printer 100 (100F) of any one of (3) to (9) above further includes: a platen roller 102 arranged to face the plurality of heat generation portions 41 and configured to transport a medium arranged between the platen roller 102 and the thermal printhead 1. The medium is an ink ribbon 201 and a paper, or a thermal paper.

With this configuration, it is possible to stably perform the printing using the ink ribbon 201 and the paper, or the thermal paper.

While certain embodiments have been described, these embodiments have been presented by way of example only, and are not intended to limit the scope of the disclosures. Indeed, the embodiments described herein may be embodied in a variety of other forms. Further, various omissions, substitutions, and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A thermal printhead, comprising:
a substrate having a main surface and protrusions protruding from the main surface and extending in a main scanning direction;
a resistor layer including a plurality of heat generation portions arranged on the protrusions of the substrate in the main scanning direction and configured to generate heat when supplied with an electric current; and
a driver circuit configured to apply the electric current to the plurality of heat generation portions based on an external signal,
wherein each of the protrusions includes a flat portion substantially parallel to the main surface, a first inclined portion configured to be connected to a first end of the flat portion in a sub-scanning direction and inclined toward an end portion of the substrate, a second inclined portion configured to connect the first inclined portion to the main surface at a larger angle than the first inclined portion with respect to the main surface, a third inclined portion configured to be connected to a second end of the flat portion in the sub-scanning direction and inclined to face the first inclined portion, and a fourth inclined portion configured to connect the third inclined portion to the main surface at a larger angle than the third inclined portion with respect to the main surface,
wherein the plurality of heat generation portions are provided over a range from the first inclined portion to the flat portion, and
wherein a dimension of the flat portion in the sub-scanning direction is 100 μm to 500 μm.

2. The thermal printhead of claim 1, wherein a shortest distance in the sub-scanning direction from a boundary between the second inclined portion and the main surface to the end portion of the substrate is 0 to 10 μm.

3. A thermal printer, comprising:
the thermal printhead of claim 1; and
a control device configured to transmit a signal to the driver circuit,
wherein the control device transmits, to the driver circuit, the signal having a number of divisions of 2 or more, which is the number of times that the corresponding heat generation portion among the plurality of heat generation portions is applied with the electric current per line which is a printing unit.

4. The thermal printer of claim 3, wherein the control device controls the signal so that the number of divisions of the signal when a printing speed is a first speed is greater than the number of divisions of the signal when the printing speed is a second speed faster than the first speed.

5. The thermal printer of claim 3, wherein the control device controls the signal so that a current application time of a first signal when printing starts is longer than a current application time of a subsequent signal.

6. The thermal printer of claim 4, wherein the control device controls the signal so that a current application time of a first signal at the start of printing when a printing speed is a second speed is longer than a current application time of the first signal at the start of printing when the printing speed is a first speed slower than the second speed.

7. The thermal printer of claim 3, further comprising:
a temperature sensor configured to be capable of measuring a temperature,
wherein the control device applies the electric current to the plurality of heat generation portions in advance so that the temperature of the temperature sensor is equal to or higher than a first temperature before printing starts.

8. The thermal printer of claim 3, further comprising:
a temperature sensor configured to be capable of measuring a temperature;
a heat dissipation member configured to partially dissipate the heat generated by the plurality of heat generation portions to the outside via the substrate; and
a resistor part whose center position is located in a range from a position closer to the plurality of heat generation portions to a center of the heat dissipation member in the sub-scanning direction and located near the center of the heat dissipation member in the main scanning direction,
wherein the resistor part is installed on a back surface of the heat dissipation member or at a location where a cutout is provided inside the heat dissipation member, and configured to generate the heat when supplied with the electric current, and
wherein the control device applies the electric current to the resistor part so that the temperature of the temperature sensor is equal to or higher than a first temperature before printing starts.

9. The thermal printer of claim 3, further comprising:
a temperature sensor configured to be capable of measuring a temperature;
wherein the control device controls the signal so that the number of divisions of the signal after the temperature of the temperature sensor reaches a second temperature is greater than the number of divisions of the signal before the temperature of the temperature sensor reaches the second temperature.

10. The thermal printer of claim 3, further comprising:
a platen roller arranged to face the plurality of heat generation portions and configured to transport a medium arranged between the platen roller and the thermal printhead,
wherein the medium is an ink ribbon and a paper, or a thermal paper.
